(19) United States
(12) Patent Application Publication
(10) Pub. No.: US 2006/0245819 A1
(43) Pub. Date: Nov. 2, 2006

(54) Dispenser/spreader article for spackling and paste

(76) Inventor: Richard L. Owens, CONYERS, GA (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/552,789

(22) PCT Filed: Apr. 16, 2004
(86) PCT No.: PCT/US04/11769

§ 371 Date: Oct. 11, 2005

(30) Foreign Application Priority Data
Apr. 22, 2003 (US) 10/421453

(51) Int. Cl. B05C 11/00; B43K 1/06

(52) U.S. Cl. 401/266; 401/265

(57) ABSTRACT

A spreader includes a first and second preformed components of resilient PVC sheet and deformable PVC sheet, respectively, bonded together and shaped to form a blister-shaped sealed container filled with spackling material or paste. The resilient sheet forms an enlarged blade suitable for spreading the spackling material and forms an opening at the one end for dispensing the spackling material onto the blade and includes ribs to stiffen the blade. A hole in the other end forms a docking station. A resilient plug fits in the opening to seal the opening to maintain the spackling material for later use, and is repositionable into the docking station for holding the plug while using the spreader. The container is suitably sized for grasping and manipulating the blade while dispensing material.

This application is a continuation-in-part of application Ser. No. 10/421,453, filed Apr. 22, 2003, entitled DISPENSER/SPREADER ARTICLE FOR SPACKLING AND PASTE, the entire contents of which are incorporated herein in their entirety by reference.

### BACKGROUND

The present invention relates to a dispenser/spreader article for applying and spreading paste materials, such as spackling, pastes, adhesive, and other viscous materials as defined below.

For possibly centuries, holes and imperfections in walls have been repaired using a scraping/spreading implement and a filling, repair substance. A modern tool of choice is, of course, a metal “putty knife”, which is generally resilient and about 1 to 6 inches wide. Typically, a worker scoops out a quantity of spackling material from a container using the tool, and applies the spackling material directly to a wall. For this process to work properly, the nature of spackling material in containers requires it to be more solid than liquid, but also requires that the spackling material be pasty/sticky and not too dry. At the same time, the spackling material must preferably dry quickly, so that subsequent finishing operations, such as sanding, can be completed soon after application. Disposal of unused spackling is messy and wasteful. At the same time, it is typically undesirable to put excess spackling material back into a tub because the excess spackling material can taint the whole tub with fuzz, hair, dirt, and of course, mostly-dry spackling material. When a tub runs low of material, such as at the end of a job, the material in the tub tends to dry out and/or get debris in it, such that it then contains mostly unusable spackling material, which ultimately ends up going into the trash can. It is fair to say that the above repair method is very often quite wasteful.

Spackling materials are especially difficult to deal with since they are more viscous and more prone to drying and clumping than many creams and adhesives/caulking compounds. Further, spackling materials (by design) tend to dry quickly and skin over and/or form crusts or cake-like clumps that render the material difficult to apply. Thus, spackling materials are notorious for not flowing well through long or narrow channels. This makes sense since the spackling materials are intended to plug up and cover holes, cracks, and crevices. However, this property makes dispensing of spackling materials more difficult.

One proposed method to improve the process of applying spackling materials is to use a collapsible tube filled with diluted spackling material. These tubes have long narrow spouts which are to be cut to allow the spackling material to be dispensed wherever desired by squeezing the tube and applying directly to the crack or nail hole, or by placing the dispensing spout directly at the best spot on the blade. Excess spackling material can then be wiped off with a putty knife, leaving a nice smooth surface. A problem is that the long narrow spouts require diluted spackling material so that the spackling material can be dispensed through the long narrow passageways of the spouts. As a result, the diluted low-viscosity spackling material doesn't work well on larger holes and cracks, since it sags and/or shrinks unacceptably upon drying.

Another effort at improving the repair process was recently introduced by the Dap Company as the Patch Stick® product. This product utilized a “push-up” tube as the dispensing device. Push-up tubes dispense by turning a knob clockwise at the bottom, which forces a plunger inside to move upward, thus forcing the material inside to exit out the opposite open end. A very desirable feature of push-up tubes is that twisting counterclockwise can “suck back” some of the dispensed material. Push-up tubes have been used for years with solid underarm deodorant, glue, lip balm, lipstick, sun block, solid pre-wash stain treatments, etc. However, push-up tubes are expensive since they require uniquely shaped parts with tight tolerances that interact to provide the push-up action. Also, the cap spreader of the tube is awkward to hold and is not shaped for use as a firm grip when spreading spackling material. Further, material that is sucked back into the tube can be contaminated, leading to problems at a time when the consumer expects to be able to reuse the product, causing frustration of the worker/user. The Patch Stick® instructions suggest removing its tall hollow cap, twisting the bottom to dispense some spackling from the top, rubbing the spackling onto the hole or crack, and scraping off excess material with the cap. Alternatively, the cap can be used to scrape off spackling from the tube and then apply the dispensed material to the wall. This system works very similarly to the collapsible tube method previously described, but has the advantage of the tube being rigid. Moreover, when the collapsible tube is almost empty, the collapsible tube is more difficult to grip than the stiff-sided push-up tube. This leads to substantial waste, since partially-filled collapsible tubes are discarded.

A serious problem with the Dap Patch Stick® product that was tested is that, as the spackling material is dispensed and used, the spackling material tends to become drier and therefore less cohesive. Upon close examination, it was discovered that the seal at the rear end of the tube fits snugly and rather airtight only when the tube is full. When partially emptied, air enters into the space behind the plunger and allows drying of the spackling material. Another source of moisture loss is at the top where the “seal” is not bonded, but merely lying on the spackling material. This allows the air in the hollow cap to dry the exposed spackling material. Drier spackling material tends to crumble, lose its plastic nature, and not adhere properly to the wall or spreader cap.

The prior art that combined a spreader blade with a material supply of paste that I, the inventor, investigated included one or more of the following negative features: 1) a narrow or long channel that was not well-suited for nor usable for dispensing spackling or adhesive paste; 2) an obstruction to the dispensing hole or dispensing area that impedes or prevents wiping the dispensing area clean for subsequent later use of the apparatus; 3) no plug or seal that adequately prevents material at the dispensing site from drying out; 4) no docking location for any such plug, nor for convenient storage of a sealing plug so that it does not get lost while using the apparatus; 5) prior art uses a cylindrical tube which requires or includes a long dispensing channel and which does not provide an ergonomic handle; 6) no straight, smooth scraping edge with squared or relatively-sharp corners to facilitate application of the spackling material to concave edges and corners; 7) no resilient blade that does a good job of simulating a putty-knife blade with proper memory and resiliency of the blade; and 8) prior art tends to be limited to a single use only due to drying of spackling material around the dispensing location or due to contamination (i.e. dust, debris, insect remains, etc.) of spackling material sucked back or back-mixed with the spackling material in the apparatus.

In addition, it is important to mention that many companies in the painting and wall-surfacing business (professional and amateurs) are maximizing efficiency and simultaneously minimizing manual time on jobs partially by using disposable equipment and supplies. This can reduce cleanup time dramatically, which is especially important for jobs that are relatively small, and/or where small quantities of spackling material are required. For example, professional crews that repair apartments and condominiums are an example where such a dispenser is desired. However, small jobs can result in tremendous waste unless an effective low-cost dispenser is provided where wasted spackling material is minimized. Further, even though disposable equipment has advantages, professionals still prefer a spreader that gives them the blade control and flexible feel of professional metal-bladed putty knives.

Aside from the business of actually using a spreading/dispensing article, it is important that any disposable spreader/spreader article be made from low-cost materials, and also be adapted to facilitate filling during the manufacturing process when spackling material is loaded into the dispensing article. In regard to the materials, I spent considerable time trying to find a person or company able to bond flexible PVC to rigid PVC (the terms flexible PVC and rigid PVC are recognized terms for markedly different materials in the industry). With great difficulty, I came up with a single company who was willing to try and bond the two materials. I have concluded that it is unobvious to bond these two materials, particularly in the present arrangement, and hence I believe this to be a part of my invention. In regard to filling, I spent considerable time trying to determine a best way to load spackling and/or paste material into the present arrangement, both by filling before bonding of the two PVC components and by filling after bonding of the two PVC components. The solution of bonding prior to filling and then providing an air bleed hole to facilitate filling is believed to be totally unobvious to a person of ordinary skill, due to the logic of filling this type of article prior to bonding. However, spackling and pastes potentially complicate the bonding process by contaminating the bonding site. Imperfect bonding leads to imperfections which are problematic given the sensitivity of the present spackling material to drying out and/or clumping (which problems are discovered only after considerable shelf time in a store or in a person's supply closet). Further, I suggest that it is unobvious to include an air bleed hole where the material is subject to drying problems. For these reasons, I believe the present arrangement including the air bleed hole and then covering it with a moisture-resistant self-adhesive seal is also part of my invention.

Accordingly, an apparatus is desired that provides the advantages noted above and that solves the disadvantages.

### SUMMARY OF THE PRESENT INVENTION

In one aspect of the present invention, an article includes a spreader having a sealed container forming a blade at one end and having a dispensing opening suitable for dispensing paste material from the container onto the blade. The article still further includes a docking structure remote from the blade, the sealed container being adapted to be filled with the paste material and for dispensing the paste material therefrom. A removable plug is provided that is shaped to sealingly engage the dispensing opening to preserve the paste material for later use, and is further shaped to engage the docking structure for storage while the article is being used to apply and spread the paste material with the blade.

In another aspect of the present invention, an article includes a spreader having a preformed resilient sheet component and a preformed deformable sheet component bonded together and shaped to form a blister-shaped sealed container with a cavity therebetween. The sealed container is airtight and water-tight and is adapted to contain spackling material. The resilient sheet component forms a blade at one end suitable for spreading the spackling material and forms an opening at the one end for dispensing the spackling material onto the blade. A removable moisture-resistant adhesive seal sealingly covers the opening.

In another aspect of the present invention, an article includes a resilient sheet component and a deformable sheet component bonded together to form a blister-shaped container. The resilient sheet has an enlarged blade formed at a blade end and a dispenser hole also formed at the blade end for dispensing material from the container onto the blade and further has an air bleed hole remote from the dispenser hole for facilitating filling of the container. At least one removable sealing member is provided that is shaped to sealingly cover the dispenser hole and the air bleed hole to maintain an airtight moisture-resistant seal of the container.

In another aspect of the present invention, an article includes a first preformed component made from a resilient sheet of rigid PVC material and a second preformed component made from a deformable sheet of flexible PVC material bonded together along a continuous bond line and shaped to form an airtight blister-shaped sealed container therebetween. The second preformed component has a perimeter flange bonded to the first preformed component and the first preformed component includes first ribs extending parallel along a portion of the perimeter flange to assist in positioning the resilient and deformable sheets together during a bonding process. The first preformed component includes an enlarged end forming a blade and further includes second ribs extending onto the enlarged end to stiffen the blade for improved control when using the blade and to permit a thinner material to be used for the resilient sheet. Paste material sensitive to drying from exposure to atmosphere fills the container. The resilient sheet includes a dispenser opening in the enlarged end for dispensing the paste material from the container onto the enlarged end, and includes a docking station remote from the enlarged end. The docking station is shaped to simulate the dispenser opening and is located remotely from the enlarged end and the opening, so that a plug for the opening can be held on the spreader without interfering with dispensing paste material onto the enlarged end and without interfering with using the enlarged end to spread the paste material.

Preferably, the docking station is slightly larger to facilitate use.

In another aspect of the present invention, a method includes steps of forming a first component of flexible PVC material, including a perimeter flange; bonding a second component of rigid PVC material; and bonding the perimeter flange of the flexible PVC material to the rigid PVC material with a continuous bond to form a blister package.

In another aspect of the present invention, an article comprises a preformed first component made from a flexible thermoplastic polymer and having a continuous perimeter flange. A preformed second component is made from a rigid thermoplastic polymer with a blade edge and a dispensing hole formed on one end. The perimeter flange is bonded to the second component with a portion of the perimeter flange extending between the blade edge and the dispensing hole.

In still another aspect of the present invention, an article includes a resilient sheet-like component and a deformable sheet-like component bonded together and shaped to form a plurality of blister-shaped sealed containers therebetween. The containers each include a wide end and a narrow end. Paste material, sensitive to drying or curing upon exposure to atmosphere, fills each of the containers. The resilient sheet includes an opening in the enlarged end of each of the containers for dispensing the paste material onto the enlarged end, and includes a docking station in the narrow end shaped to simulate the opening and that is located remotely from the enlarged end and the opening. By this arrangement, a plug for the opening can be held by the docking station on each individual spreader without interfering with dispensing paste material onto the enlarged end and without interfering with using the enlarged end to spread the paste material.

In a narrower aspect, the resilient sheet defined above is partially die-cut to define a plurality of individual dispenser/spreader articles from the bonded deformable and resilient sheets, with the separable dispenser/spreader articles each including one of the blister-shaped sealed containers and each further including a wide end forming a blade and a narrow end forming part of the sealed container. The wide end of each adjacent separable article is located near the narrow end on the adjacent separate article to provide a dense arrangement of articles on the deformable and resilient sheets prior to separation.

My testing and experimentation has found that an apparatus providing the following characteristics would be very desirable. Accordingly, it is an object of the present invention to include one or more or all of the following characteristics: 1) simple, one-handed operation; 2) a resilient blade similar to the feel of a steel putty knife; 3) economical to make and use; 4) disposable; 5) airtight to preserve plasticity and fluidity of the spackling material; 6) no unacceptably small channel or restriction through which the heavy-bodied spackling and adhesive pastes must be forced; 7) straight edged blade with 90° corners; 8) reusable plug that is dockable on the device; and 9) use of the device should leave the repaired hole area smooth and unblemished, not needing to be sanded.

These and other aspects, objects, and features of the present invention will be understood and appreciated by those skilled in the art upon studying the following specification, claims, and appended drawings.

### BRIEF DESCRIPTION OF DRAWINGS

FIGS. 1-3 are perspective, side, and top views of a dispenser/spreader article embodying the present invention;

FIG. 4 is an exploded perspective view of FIG. 1;

FIGS. 5-6 are top and end views of the resilient sheet shown in FIG. 4;

FIG. 7 is a plan view of two bonded sheets forming a plurality of the dispenser/spreader articles shown in FIG. 1 prior to separation into individual dispenser/spreader articles; and

FIGS. 8-9 are plan views of a die-cut resilient sheet of material (FIG. 8) and of a thermoformed deformable sheet of material (FIG. 9), which are preformed and then bonded together to form the bonded sheets of FIG. 7.

FIGS. 10-11 are a top view and an exploded perspective view of a modified version of the present apparatus;

FIGS. 12-14 are perspective, top, and end views of the stiff PVC panel of FIG. 10;

FIG. 15 is a cross section taken along the line XV-XV in FIG. 13; and

FIGS. 16-19 are perspective, top, side, and end views of the flexible PVC panel of FIG. 10.

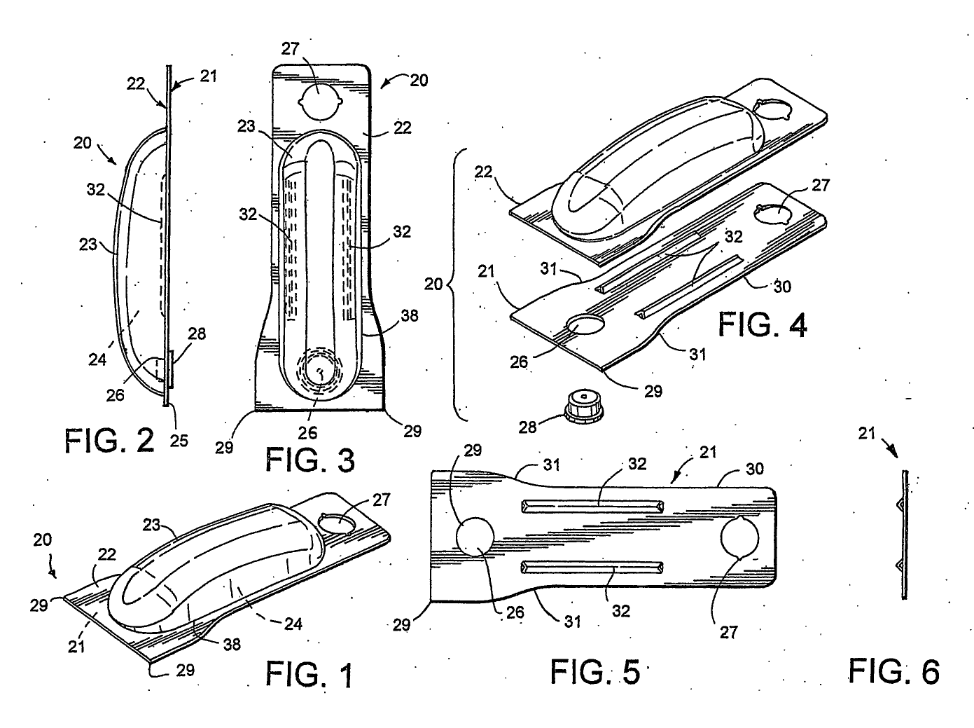

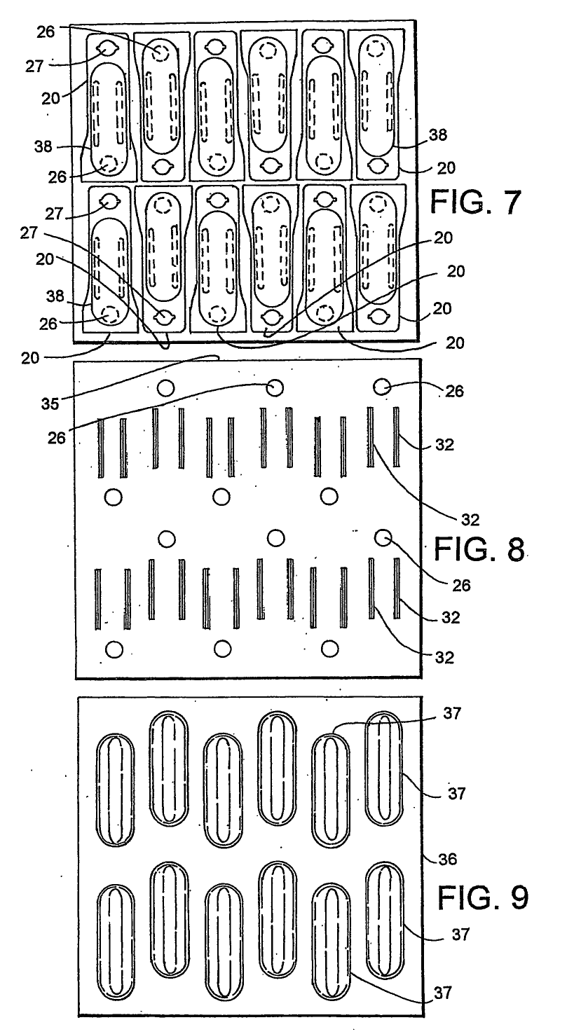

### DETAILED DESCRIPTION OF PREFERRED EMBODIMENTS

In the discussion below, “paste” is a soft, moist, smooth-textured substance that will hold its shape when applied to vertical surfaces, without distortion due to gravity. “Blister” is intended to define a bulging, bubble-like shell, with side flanges spread outward to define a plane. “Channel” defines a tube-like, elongated passage for fluid or flowable material. “Plastic” is a polymeric material capable of being molded and changed in shape. “Spackling” is a paste usable for filling holes and cracks in walls and ceiling without distortion due to gravity. “Adhesive” is a material, which will bond to vertical surfaces, without distortion due to gravity. “Thermoplastic” is a material that becomes soft and moldable when subjected to heat.

A spreader/dispenser article 20 (FIG. 14) includes a resilient sheet component 21 (often called “rigid PVC sheet” in the PVC industry) (FIG. 4) and a deformable sheet component 22 (often called “flexible sheet” in the PVC industry) bonded together and shaped to form a blister-shaped blister-like sealed container 23 filled with paste material 24, such as spackling material, adhesive, air-drying and/or air-sensitive materials. The resilient sheet component 22 forms an enlarged blade 25 at one end suitable for spreading the spackling material 24 and forms an opening 26 at the one end for dispensing the spackling material 24 onto the blade 25. A hole 27 in the other end forms docking station spaced from the opening 26. A hollow resilient plug 28, having a “top hat” shape, is positionable in the opening 26 to seal the opening 26 to keep the spackling material 25 from drying so that it is good for later use. The plug 28 is removable and can be repositioned in the docking station hole 27 for storing/holding the plug 28 while a worker is using the spreader/dispenser article 20. The portions of the sheet components 21 and 22 forming the container 23 and the area around the container 23 are suitably sized for grasping and manipulating the blade 25 while squeezing and dispensing material 24 from the container 23.

The resilient sheet component 21 (FIG. 4) has properties optimally chosen to replicate the flexibility and resiliency of spring steel, such as the spring steel of a blade on a putty knife. Workers have surprisingly strong preferences concerning a strength and flexibility of their putty knives, and the present arrangement is well-suited to meet that demand. Sheet component 21 can be substantially any desired bendable material. However, in a preferred form, it has been found that “rigid” PVC material having a thickness of about 0.020 to 0.040 inches (or more preferably 0.020 to 0.030 inches, or most preferably about 0.030 inches) and a relatively high durometer works well for the intended purpose. The handle-forming narrow end 30 of the sheet component 21 is about 2¼ inches wide, while the blade end can be any width desired such as about 3 inches wide. The leading edge of the illustrated blade is linear and straight, but it is contemplated that it can be serrated or another shape, if desired. It is preferable that the blade 25 have relatively sharp 90° corners 29 so that workers can use the blade 25 to smooth out areas found near interior wall corners, and around window casings, when using spackling material. It is also preferable that the blade 25 have a length that extends past the dispensing opening 26, and further that it include angled edges 31 that transition to the handle-forming narrow end 30 so that the blade 25 flexes and bends in a way most desirable to a worker using the article 20.

The dispenser opening 26 is preferably wide enough to prevent undue and undesirable restriction of spackling material as it exits the container 23. It is contemplated that the opening 26 should be at least about 7/16 inch (o.4 inches) in diameter for spackling materials, and more preferably is at least about ⅝ to 1 inch in diameter, and most preferably about ¾ to 13/16 inch (21 mm) in diameter. The hole 27 forming the docking station has a similar size (or slightly larger), so that the plug 28 can be easily pressed into the hole 27 for secure storage while using the article 20. The illustrated hole 27 includes notches 31 to facilitate merchandising (i.e. to facilitate hanging the article 20 on a single or double prong “J” hook, as is often used in a retail store) and to facilitate inserting and removing the plug 28. Parallel stiffening ribs 32 extend along the side of the narrow end 30, slightly inboard of the lines of bonded material forming edges of the container 23. The stiffening ribs 32 allow a thinner sheet of material to be used for component 21, thus helping keep the sheet component 21 closer in thickness to the sheet component 22, which has advantages for RF bonding the two sheet components 21 and 22 together, as discussed below.

The deformable sheet component 22 (FIG. 4) comprises a sheet of “flexible” PVC having a thickness as close to that of resilient sheet component 21 as possible, to facilitate bonding the two sheet components 21 and 22 together. The reason that same or similar thickness of sheet components 21 and 22 is preferred is believed to be due to thermal and physical movement of material in the two sheet components 21 and 22 during the bonding process of RF, sonic, or vibrational bonding processes. It is contemplated that the deformable sheet component 22 is preferably at least about 0.007 to 0.020 inches thick and more preferably between at least about 0.012 to 0.015 inches thick or slightly more. The thickness of deformable sheet component 22 is of course dependent upon the bonding technique used to bond the sheet components 21 and 22 together, and also is dependent upon the feel that the manufacturer desires to give to the end user. It is contemplated that a number of different bonding techniques can be used, such as radio-frequency (RF) bonding, heat bonding, vibrational and/or sonic bonding, adhesive bonding, sheet-to-sheet material bonding (such as by use of an evaporative solvent), and the like. In a preferred mode, RF bonding or sonic welding is preferred. Where the sheet components 21 and 22 are both of the same type material, such as PVC material, and have a similar thickness, such as 0.012 to 0.015 inches for the deformable sheet 22 and 0.020 to 0.030 inches for the rigid sheet component 21, the sheet components 21 and 22 are more easily bonded using RF bonding techniques.

Container 23 is optimally sized and shaped for grasping by the palm of a worker's hand, so that the material 24 is dispensed with a full hand squeeze (rather than a finger-only squeeze). In the illustrated arrangement, the container 23 is slightly under 2 inches wide, such as about 1.88 inches wide, with thin strips of material being left on each side of the container 23 on the narrow end 30. Further, the handle-forming end is about 5 to 6 inches long, while the blade end 25 is about 2 to 3 inches long.

The plug 28 (FIG. 4) is a resilient hollow member that is thimble-shaped or hat-shaped. The plug 28 is made of resilient vinyl or the like for good flexibility and good sealing ability, and includes a rim 33 that assists in grabbing it to remove it from dispensing opening 26 and/or from the docking station hole 27.

In a preferred method, the articles 20 are mass-produced by making several on a two-sheet laminate as follows. A first sheet of “rigid” resilient material 35 (FIG. 8) is die-cut and formed to include dispensing openings 26 and includes parallel ribs 32 for several articles 20. The illustrated sheet 35 is die-cut and formed to make twelve articles 20 (more or less could be formed, if desired). The second sheet of deformable material 36 (FIG. 9) is thermally formed to include twelve blisters 37 that correspond to the locations on the sheet 35. The two sheets 35 and 36 are then sandwiched together, and are bonded together along oblong weld lines 38. The assembled sheets 35/36 are then cut to include the holes 27 for the docking stations, and are further cut (potentially in the same die-cutting operation) to include the enlarged end forming the blade 25. Optimally, the blades 25 in each adjacent article 20 on the sheet are at opposite ends so that a maximum density of articles 20 can be formed on each sheet.

### MODIFICATION

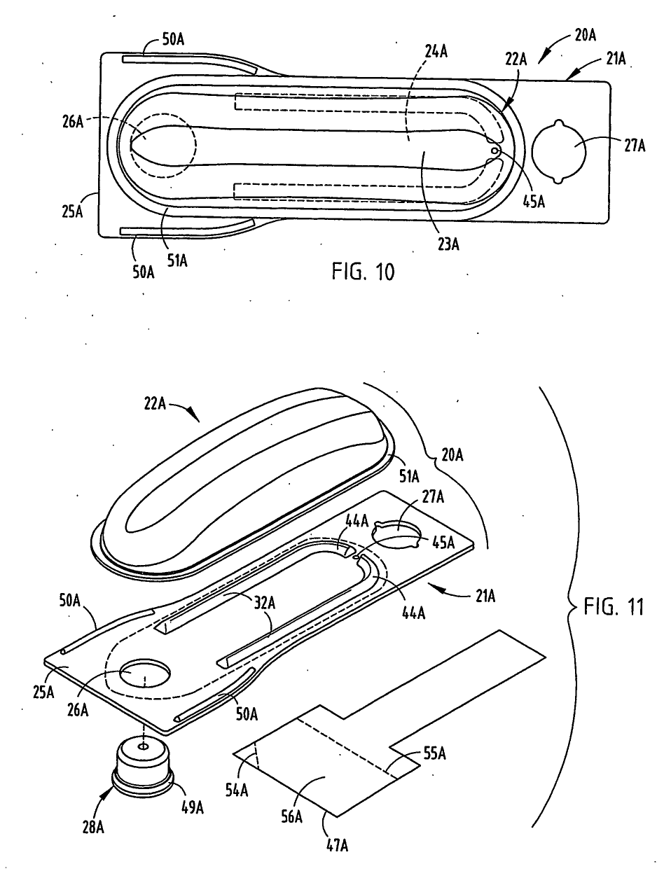

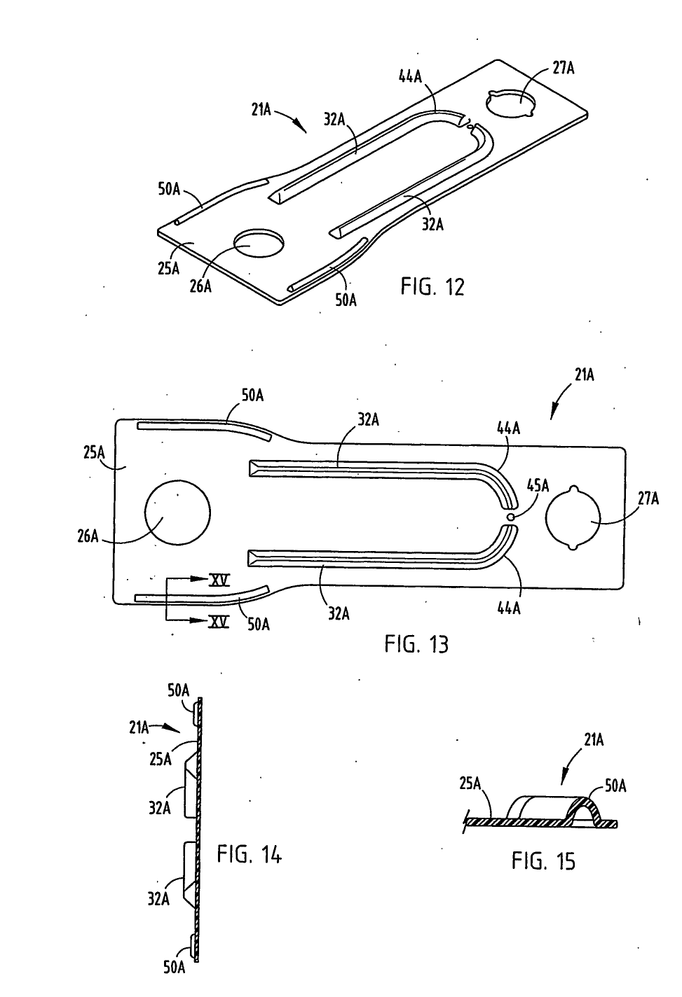

A spreader/dispenser article 20A (FIGS. 10-19) includes identical or similar components and features to the article 20 described above. To reduce redundant discussion, the same identification numbers for the article 20 are used to describe the same components and features on the article 20A, but with the addition of the letter “A”.

A spreader/dispenser article 20A (FIG. 10-11) includes a resilient sheet component 21A of rigid PVC and a deformable sheet component 22A of flexible PVC bonded together around a perimeter of the deformable sheet component 22A and shaped to form a blister-shaped sealed container 23A filled with paste material, such as spackling material, adhesive, air-drying and/or air-sensitive materials. The resilient sheet component 22A forms an enlarged blade 25A for spreading the sparkling material 24A and forms an opening 26A for dispensing the spackling material 24A onto the blade 25A. A hole 27A in the other end forms a docking station spaced from the opening 26A. A hollow resilient plug 28A, having a “top hat” shape, is positionable in the opening 26A to seal the opening 26A.

The stiff sheet component 21A (FIG. 13) is rigid PVC and has a preferred thickness of 0.030 inches, a blade width of about three inches, a handle width of about two inches, a total length of about eight inches, and a handle length of about four-and-a-half inches. The dispenser hole 26A is 21 mm (docking hole is 22 mm). The parallel ribs 32A each are extended to include an arcuate extended section 44A that extends inwardly toward each other, but which stop short of an air bleed hole 45A. The ribs 32A and extended sections 44A assist in locating the flexible sheet 22A during the RF welding operation. The air bleed hole 45A is relatively small, such as about 0.09 inches or smaller in diameter. It is sufficient in size to allow air to bleed without undesirable restriction during a step of filling the article 20A with spackling and/or paste material. At the same time, the air bleed hole 45A is sufficiently small enough to control spackling and/or paste as it is injected into the article 20A, and to prevent unacceptable squirting of the material out of the hole 45A as the filled condition is reached. Any material that does exit the hole 45A would be small enough in quantity to be easily wiped away, and/or is small enough to be covered with a moisture-resistant self-adhesive seal 47A (such as a sticky tape). Additional embossed ribs 50A are located along the opposing edges of the perimeter of the wider portion of the rigid sheet component 21A that forms the blade 25A. The ribs 50A extend as far as needed, and are as deep as needed for the preferred stiffness of the blade 25A. The illustrated ribs 50A are a constant height and shape, but they can be varied as desired for optimal flexure of the blade. The ribs 50A (and ribs 32A) also help locate the flexible sheet component 22A during the RF welding process for bonding the sheet components 21A and 22A together. The ribs 50A and 32A extend far enough so that their ends overlap (i.e. a line connecting the ends of the ribs 50A crosses the ends of the ribs 32A), although the present invention is not believed to be limited to this condition. Notably, the illustrated embossed ribs 32A have a relatively V-shaped cross-sectional shape with angled flat sides, while the illustrated embossed ribs 50A have a more radiused shape with vertically-flat sides. Testing has shown that these shapes work particularly well for their intended purposes; but nonetheless, it is contemplated that various shapes of ribs can be used.

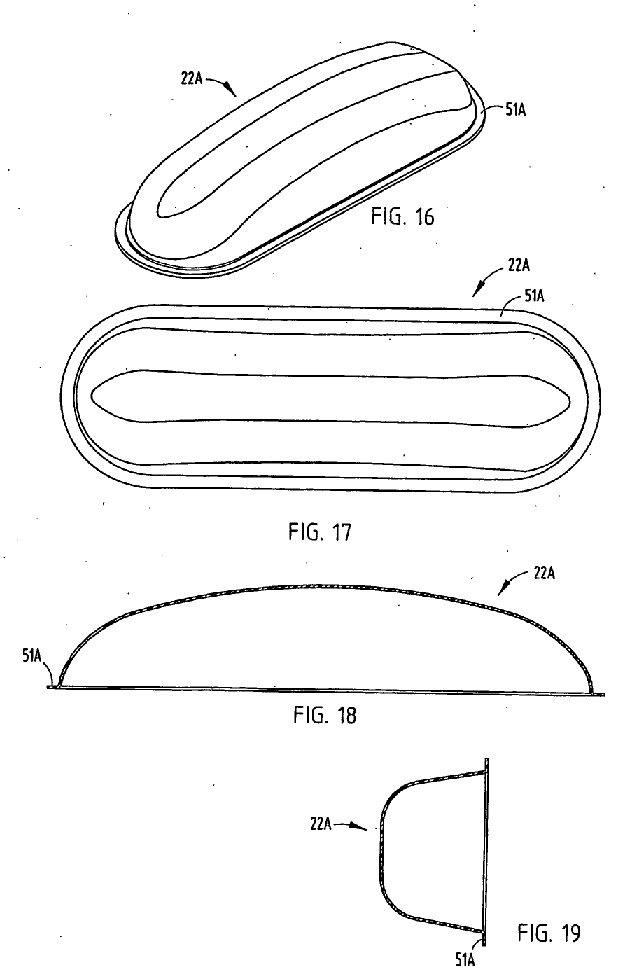

The flexible sheet component 22A (FIGS. 16-19) is obround in shape, with flat sides and radiused ends. The illustrated sheet component 22A is about 6.2 inches long, 2.2 inches wide and about 0.010 to 0.020 inches thick. It is thermally formed to a blister depth of about 1.3 inches at its highest point. Flexible PVC sheet is rated in the industry by hardnesses of 1H to 5H, with 5H being the hardest and being close to the stiffness of rigid PVC material. The present sheet component 22A is a hardness of about 3H. A flange 51A having a width of about 0.13 inches extends completely around the sheet component 22A after thermal/vacuum formation of the raised blister in a center of the flexible sheet component 22A, with the flange 51A being sufficient in width to assure an adequate landing area and good control for providing reliable bonding during the radio-frequency (RF) bonding process. RF bonding processes are known in the art, though I believe that bonding flexible PVC sheet to resilient PVC sheet is not only novel, but also non-obvious, based on my experience of trying to find a company to do the bonding that I required. It is my understanding that part of the unobviousness of bonding rigid PVC material to flexible PVC material is that flexible PVC material includes elastomers that can leach out and/or migrate to the surface and/or otherwise adversely affect the bonding dynamics including the ability to generate heat at the interface of materials. This is particularly true for RF bonding (radio frequency bonding) because of the high frequency and short amplitude of the physics of such RF bonding processes.

As manufactured, the plug 28A is stored in the hole 27A, and a moisture-resistant self-adhesive seal 47A is used to cover the outlet/dispensing hole 26A. The illustrated seal 47A is T-shaped and large enough to cover both the dispenser hole 26A and also the air bleed hole 45A. It is kiss cut at a corner location 54A to leave a pull tab, and also is perforated along line 55A so that the end portion 56A can be ripped off to uncover the dispenser hole 26A without exposing the air bleed hole 45A. Advantageously, the seal 47A can be used to carry advertising, content, logo, and instruction indicia and other printed information.

The plug 28A is a flexible vinyl, such as a hardness of number 1H-type PVC material. It includes a rim 49A around its tail end and is hollow and flexible, such that permits it to be grasped by pinching for removal, which has been found to be particularly handy when repositioning the plug 28A. The dispensing hole 26A is about 21 mm in diameter or slightly greater, but is preferably a little bit smaller than the storage hole 27A (which is 22 mm) to ensure airtight sealing against the plug 28A. The present article 20A stores up to about 5.6 fluid ounces, which appears to be an optimal size and shape for handling and also optimal for the small applications of its intended use. Nonetheless, it is contemplated that different sizes made be constructed using the present principles of invention disclosed herein.

An extensive amount of time was spent trying to duplicate the feel and structure of a professional metal putty blade for applying spackling compound, since professionals strongly prefer a particular feel and control. The present materials were chosen to meet that requirement, and they do. Further, the ribs 50A help keep the sheet component 21A to a minimum thickness. The present materials optimally used rigid and flexible PVC. As noted above, finding a company to bond rigid and flexible PVC was difficult, with people skilled in the art of bonding materials repeatedly telling me that it was not done and not possible to do so with the quality and reliability that I required. As noted above, I spent considerable time trying to find a person or company able to bond flexible PVC to rigid PVC (the terms flexible PVC and rigid PVC are recognized terms for markedly different materials in the industry). With great difficulty, I found a single company (i.e., Transparent Container, Bensenville, Ill.) who, though they had never done it before, was willing to try to bond the two materials at my direction. I have concluded that it is unobvious to bond these two materials with the quality and reliability that I require (especially where materials are so prone to messing up the bonding process and where the materials dry out and have “clumping” problems if the seal is not perfect along its entire length). Hence, I believe the bonding of flexible and rigid PVC to be a part of my invention. In regard to filling, I spent considerable time trying to determine a best way to load spackling and/or paste material into the present arrangement, both by filling before bonding of the two PVC sheets and by filling after bonding of the two PVC sheets. The solution of filling after bonding and then providing an air bleed hole to facilitate filling is believed to be totally unobvious to a person of ordinary skill. One reason is because there is an inherent logic to placing the spackling material (or paste) into the open pan-shaped blister-shaped flexible sheet prior to bonding the resilient sheet to the flexible sheet. However, my testing showed that spackling and pastes complicate the bonding process and can lead to imperfections and air leaks along the bond line, particularly given the sensitivity of the present spackling material to drying out and/or clumping (which problems are discovered only after considerable shelf time in a retail store or in a person's supply closet). Further, trapped air can be a problem, leading to drying of the spackling or paste material. Further, it is unobvious to include an air bleed hole where the material is sensitive to drying. For these reasons, I believe the present arrangement including the air bleed hole and the step of covering the dispenser hole and the air-bleed hole with a moisture-resistant self-adhesive seal is also part of my invention.

The present illustrated materials were PVC. The flexible PVC that I am using has a harness rating of Shore A 95 (comparable to Shore D 40). Rigid PVC has a very high hardness rating of Shore R 115. Note that the R scale is for higher degrees of hardness than Shore D and Shore D is for higher degrees of hardness than Shore A. However, I specifically contemplate that, though PVC is preferred, other sheet materials can be used, where one of the sheet materials is flexible and one of the sheet materials is relatively stiff and rigid. For example, high density polyethylene (HDPE) and low density polyethylene (LDPE) could be used. Also, homopolymer polypropylene and copolymer polypropylene could be used. Polypropylene is rated at between 14-25% softer than rigid PVC, so thicker polypropylene sheet would probably be required, or additional embossed stiffening ribs. These materials are difficult to bond, yet bondable to form the present inventive arrangement and have adequate properties for the present arrangement.

It is to be understood that variations and modifications can be made on the aforementioned structure without departing from the concepts of the present invention, and further it is to be understood that such concepts are intended to be covered by the following claims unless these claims by their language expressly state otherwise.

1. An article comprising:
a spreader including a sealed container forming a blade at one end and having a dispensing opening suitable for dispensing paste material from the container onto the blade and still further including a docking structure remote from the blade, the sealed container being adapted to be filled with the paste material and for dispensing the paste material therefrom; and
a removable plug shaped to sealingly engage the dispensing opening to preserve the paste material for later use, and further shaped to engage the docking structure for storage while the article is being used to apply and spread the paste material with the blade.

2. The article defined in claim 1, wherein the docking structure for the plug is located at an end opposite the blade.

3. The article defined in claim 2, wherein the docking structure includes a second hole that is slightly larger than the dispensing opening.

4. The article defined in claim 2, wherein the second hole includes side notches to facilitate receipt of a “J” hook for merchandising displays.

5. The article defined in claim 1, wherein the spreader includes at least one side that is deformable and collapsible.

6. The article defined in claim 1, wherein the spreader includes a deformable sheet of material forming a blister-like, deformable side of the container.

7. The article defined in claim 6, wherein the spreader includes a relatively resilient sheet forming a second side of the container and also forming the blade.

8-19. (canceled)

20. An article comprising:
a spreader including a preformed resilient sheet component and a preformed deformable sheet component bonded together and shaped to form a blister-shaped sealed container with a cavity therebetween, the sealed container being airtight and water-tight and adapted to contain spackling material; the resilient sheet component forming a blade at one end suitable for spreading the spackling material and forming an opening at the one end for dispensing the spackling material onto the blade, the resilient sheet including at least two ribs that extend toward the blade for stiffening the blade; and
a removable moisture-resistant adhesive seal sealingly covering the opening.

21. The article defined in claim 20, including a removable, resilient plug shaped to sealingly engage and close the opening.

22. The article defined in claim 21, including a docking station similarly shaped like the opening that is located away from the blade and opening, so that the plug can be held on the spreader without interfering with dispensing spackling material onto the blade and without interfering with using the article including the blade.

23. The article defined in claim 22, wherein the docking station is located at an end opposite the blade and comprises a docking hole.

24. The article defined in claim 20, wherein the resilient sheet component is at least 0.030 inches thick and the deformable sheet component is between 0.010 and 0.030 inches thick.

25. (canceled)

26. The article defined in claim 20, wherein the at least two ribs extend parallel each other.

27. An article comprising:
a resilient sheet component and a deformable sheet component bonded together to form a blister-shaped container, the resilient sheet having an enlarged blade formed at a blade end and a dispenser hole also formed at the blade end for dispensing material from the container onto the blade and further having an air bleed hole remote from the dispenser hole for facilitating filling of the container;
at least one removable sealing member sealingly covering the dispenser hole; and
at least one second sealing member sealingly covering the air bleed hole to maintain an airtight moisture-resistant seal of the container.

28. The article defined in claim 27, wherein the resilient sheet component includes an opposite end that is positioned opposite the blade end and that includes a holder hole.

29. The article defined in claim 27, wherein the resilient sheet component is a rigid PVC material and the deformable sheet component is a flexible PVC material bonded together along a continuous uninterrupted bond line.

30. The article defined in claim 27, including a plug shaped to fit sealingly into the dispenser hole to maintain an airtight seal of the container, and shaped to fit into a holder hole in the resilient sheet component for secure storage while using the article to spread a substance dispensed from the container.

31. An article comprising:
a first preformed component made from a first sheet of resilient material having a relatively constant wall thickness and a second preformed component made from a deformable sheet of flexible material bonded together along a continuous bond line and shaped to form an airtight blister-shaped sealed container therebetween, the second preformed component having a perimeter flange bonded to the first preformed component and the first preformed component including first ribs extending along a portion of the perimeter flange to assist in locating the resilient and deformable sheets together during a bonding process; the first preformed component including an enlarged end forming a blade; and
paste material sensitive to drying from exposure to atmosphere filling the container.

32-33. (canceled)

34. A method comprising steps of:
forming a first sheet section of flexible material, including a perimeter flange;
forming a second sheet section of resilient material, one of the first and second sheet sections having a dispenser opening and an air bleed hole spaced from the dispenser opening;
bonding the perimeter flange of the flexible material to the resilient material with a continuous bond to form a blister package with a cavity;
filling the cavity with a paste through the dispenser opening while bleeding air through the air bleed hole; and
sealing the dispenser opening and the air bleed hole to prevent the paste from drying.

35. The method defined in claim 34, wherein the step of bonding includes RF welding.

36-37. (canceled)

38. The method defined in claim 34, including forming embossed ribs in the resilient material.

39-42. (canceled)

43. An article comprising:
a preformed first component made from a flexible thermoplastic polymer and having a continuous perimeter flange;
a preformed second component made from a resilient thermoplastic polymer with a blade edge and a dispensing hole formed on one end and an air bleed hole; and
the perimeter flange being bonded to the second component to define a cavity and having a portion of the perimeter flange extending between the blade edge and the dispensing hole;
a paste material filling the cavity, the paste material being sensitive to drying out and clumping; and
a seal covering at least the air bleed hole.

44. The article defined in claim 43, wherein the flexible and resilient thermoplastic polymers are flexible and rigid PVC sheet materials, respectively.

45. The article defined in claim 31, wherein the resilient sheet includes a dispenser opening in the enlarged end for dispensing the paste material from the container onto the enlarged end.

46. The article defined in claim 45, wherein the resilient sheet includes a docking station remote from the enlarged end and shaped to simulate the dispenser opening and that is located remotely from the enlarged end and the opening, so that a plug for the opening can be held on the spreader without interfering with dispensing paste material onto the enlarged end and without interfering with using the enlarged end to spread the paste material.

47. The article defined in claim 45, including an adhesive moisture-resistant removable seal covering the dispenser opening.

48. The article defined in claim 45, including an air bleed hole spaced from the dispenser opening, the air bleed hole being positioned to facilitate filling the container with material, and a seal sealingly closing the air bleed hole.

49. The article defined in claim 31, wherein the first preformed component includes second ribs extending onto the enlarged end to stiffen the blade and to permit thinner material to be used for the first sheet.

50. The method defined in claim 34, wherein the flexible and resilient material are PVC materials.
